(19) United States
(12) Patent Application Publication
(10) Pub. No.: US 2026/0300407 A1
(43) Pub. Date: Oct. 1, 2026

(54) DATA CLUSTERING USING DENSITY-BASED SILHOUETTE SCORES

(71) Applicant: Infosys Limited, Bangalore (IN)

(72) Inventor: Janani Varun, Chennai (IN)

(73) Assignee: Infosys Limited, Bangalore (IN)

(21) Appl. No.: 19/094,875

(22) Filed: Mar. 29, 2025

(30) Foreign Application Priority Data
Mar. 26, 2025 (IN) 202541028377

(51) Int. Cl. G06F 16/906

(52) U.S. Cl. CPC G06F 16/906

(57) ABSTRACT

A clustering technique using density-based silhouette scores is provided. Based on a cluster count, a clustering operation is executed on data points to generate various clusters. For each data point, a density score, indicating the number of data points within a predefined range from the corresponding data point in the same cluster, is determined. Based on the density score, weighted distances are determined for each data point. Based on the density score and the weighted distances, a silhouette score is generated for each data point. A cluster silhouette score is computed for each cluster as an average of silhouette scores of all data points within the cluster. If any cluster silhouette score is less than a threshold score, the cluster count is updated based on the cluster silhouette scores, and the process is repeated until all cluster silhouette scores are equal to or greater than the threshold score.

### FIELD OF THE DISCLOSURE

Various embodiments of the present disclosure relate generally to data clustering. More specifically, various embodiments of the present disclosure relate to data clustering using density-based silhouette scores.

### BACKGROUND

Clustering is a widely used technique for grouping data points into clusters or categories based on similarity. Clustering is often employed in business processes within legacy systems, such as inventory management, supply chain optimization, and customer relationship management. The fundamental objective of clustering is to group data points such that data points within a cluster are similar to each other in comparison to data points in other clusters. Various clustering algorithms have been developed to achieve this goal, such as k-means clustering, hierarchical clustering, and density-based clustering (e.g., density-based spatial clustering of applications with noise (DBSCAN)). While several clustering algorithms are available, they often lack a robust method for evaluating the appropriateness of the clustering structure. A poor clustering solution can result in inaccurate or misleading results that fail to capture the true underlying structure of the data points. These challenges make it difficult for traditional clustering methods to accurately group the data points, often leading to misclassification or poorly defined cluster boundaries.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present disclosure and with reference to the drawings.

### SUMMARY

Methods and systems for data clustering using density-based silhouette scores are provided substantially as shown in, and described in connection with, at least one of the figures.

In an embodiment of the present disclosure, a system is disclosed. The system includes processing circuitry. The processing circuitry is configured to execute, based on a first cluster count, a clustering operation on a plurality of data points to generate a first plurality of clusters. A first cluster comprises a first set of data points of the plurality of data points. The processing circuitry is further configured to determine, for a first data point of the first set of data points, a first density score that is indicative of a number of data points in the first cluster within a predefined range from the first data point. Further, the processing circuitry is configured to determine, for the first data point, based on the first density score, a first set of weighted distances, with a first weighted distance being determined between the first data point and a second data point of the first set of data points. The processing circuitry is further configured to generate a first set of silhouette scores for the first set of data points, with a first silhouette score for the first data point generated based on the first density score and the first set of weighted distances. Furthermore, the processing circuitry is configured to compute a first plurality of cluster silhouette scores for the first plurality of clusters, with a first cluster silhouette score for the first cluster computed based on the first set of silhouette scores. The clustering of the plurality of data points is controlled based on the first plurality of cluster silhouette scores.

In some embodiments, a number of clusters in the first plurality of clusters is equal to the first cluster count.

In some embodiments, the clustering operation corresponds to one of a k-means clustering operation, a density-based spatial clustering of applications with noise (DBSCAN) operation, a divisive hierarchical clustering operation, or a spectral clustering operation.

In some embodiments, to determine the first weighted distance between the first data point and the second data point, the processing circuitry is further configured to determine a first distance between the first data point and the second data point, and adjust the first distance based on the first density score.

In some embodiments, the adjusted first distance corresponds to a product of the first distance and the first density score.

In some embodiments, the first distance between the first data point and the second data point corresponds to a Euclidian distance.

In some embodiments, the processing circuitry is further configured to generate a first intra-cluster distance for the first data point based on the first set of weighted distances. The first intra-cluster distance corresponds to an average of the first set of weighted distances. The first silhouette score for the first data point is generated based on the first density score and the first intra-cluster distance.

In some embodiments, the processing circuitry is further configured to determine a set of distances between the first data point and a second set of data points of a second cluster of the plurality of clusters. The second cluster is a k-nearest neighbor of the first cluster. The first silhouette score for the first data point is generated further based on a first inter-cluster distance that corresponds to an average of the set of distances.

In some embodiments, the first cluster silhouette score for the first cluster corresponds to an average of the first set of silhouette scores.

In some embodiments, the processing circuitry is configured to determine the first density score for the first data point using a k-nearest neighbors' technique.

In some embodiments, the processing circuitry is further configured to extract the plurality of data points from a source file associated with a legacy system.

In some embodiments, the source file corresponds to a code block associated with the legacy system. The plurality of data points extracted from the source file corresponds to a plurality of business rules associated with the code block.

In some embodiments, to execute the clustering operation on the plurality of data points, the processing circuitry is further configured to transform the plurality of data points into a plurality of embedding vectors, with each embedding vector representing a distinct data attribute of the legacy system. The first cluster comprises a first set of embedding vectors, of the plurality of embedding vectors, corresponding to the first set of data points.

In some embodiments, the processing circuitry is configured to transform the plurality of data points into the plurality of embedding vectors based on a Universal Sentence Encoder (USE) technique.

In some embodiments, the processing circuitry is further configured to compare each of the first plurality of cluster silhouette scores with a threshold score and determine a second cluster count for the clustering operation in response to at least one of the first plurality of cluster silhouette scores being less than the threshold score. The second cluster count is determined based on the first plurality of cluster silhouette scores. The processing circuitry is further configured to re-execute, based on the second cluster count, the clustering operation on the plurality of data points to generate a second plurality of clusters. A number of clusters in the second plurality of clusters is equal to the second cluster count.

In some embodiments, the processing circuitry is further configured to compute a second plurality of cluster silhouette scores for the second plurality of clusters, compare each of the second plurality of cluster silhouette scores with the threshold score, and generate, in response to each of the second plurality of cluster silhouette scores being equal to or greater than the threshold score, one or more system architecture elements based on the second plurality of clusters.

In some embodiments, the plurality of data points corresponds to a plurality of business rules associated with a code block. Each cluster, of the second plurality of clusters, includes a set of business rules of the plurality of business rules. Each cluster of the second plurality of clusters corresponds to an entity associated with the code block. The one or more system architecture elements are generated in conformity with the entity and the set of business rules associated with each cluster of the second plurality of clusters.

In some embodiments, the processing circuitry is configured to execute a combination of a within-cluster sum of squares (WCSS) analysis and a silhouette analysis on the first plurality of cluster silhouette scores to determine the second cluster count.

In another embodiment of the present disclosure, a method is disclosed. The method comprises executing, by processing circuitry, based on a first cluster count, a clustering operation on a plurality of data points to generate a first plurality of clusters, with a first cluster comprising a first set of data points, of the plurality of data points. Further, the method comprises determining, by the processing circuitry, for a first data point of the first set of data points, a first density score that is indicative of a number of data points in the first cluster within a predefined range from the first data point. The method also comprises determining, by the processing circuitry, for the first data point, based on the first density score, a first set of weighted distances, with a first weighted distance being determined between the first data point and a second data point of the first set of data points. The method further comprises generating, by the processing circuitry, a first set of silhouette scores for the first set of data points, with a first silhouette score for the first data point generated based on the first density score and the first set of weighted distances. Further, the method comprises computing, by the processing circuitry, a first plurality of cluster silhouette scores for the first plurality of clusters, with a first cluster silhouette score for the first cluster computed based on the first set of silhouette scores. The clustering of the plurality of data points is controlled based on the first plurality of cluster silhouette scores.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 is a schematic diagram that illustrates an environment for data clustering using density-based silhouette scores, consistent with disclosed embodiments of the present disclosure;

FIG. 2 is a block diagram of processing circuitry of the environment of FIG. 1, consistent with disclosed embodiments of the present disclosure;

FIG. 3 depicts a cluster representation graph that illustrates a cluster count determined based on conventional silhouette scores, consistent with disclosed embodiments of the present disclosure;

FIG. 4 depicts a cluster representation graph that illustrates a cluster count determined based on density-based silhouette scores, consistent with disclosed embodiments of the present disclosure;

FIGS. 5A and 5B collectively, represents a flowchart that illustrates a method for data clustering using density-based silhouette scores, consistent with disclosed embodiments of the present disclosure; and

FIG. 6 shows an example computing system for carrying out the methods of the present disclosure, consistent with disclosed embodiments of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview:

Conventionally, data clustering may be performed using a silhouette technique. In the silhouette technique, clusters are assumed to be convex and equally dense (e.g., of uniform size). However, this assumption does not always hold in practice. In many cases, the clusters may exhibit arbitrary shapes and varying densities, which complicates the ability to maintain cohesion and separation of data points within the clusters. These challenges make it difficult for traditional clustering methods to accurately group data points, often resulting in misclassification or poorly defined cluster boundaries. Consequently, this can lead to incorrect assessments and potentially misinformed decisions.

The present disclosure addresses these limitations by providing a system and method for data clustering using density-based silhouette scores. A clustering operation is executed on a plurality of data points based on an initial cluster count, generating a first set of clusters. A first cluster in the first set of clusters includes a first set of data points. A density score is determined for each data point in the first set of data points, indicating how many data points from the same cluster are within a predefined range. Using the density score, a set of weighted distances is computed between each data point and other data points within the first cluster. Silhouette scores are then generated for each data point of the first cluster, with each silhouette score generated based on the density score and the weighted distances. Subsequently, a cluster silhouette score for each cluster is calculated by averaging the silhouette scores for all associated data points. Each cluster silhouette score represents the quality of the clustering for a specific cluster.

If any of the cluster silhouette scores is less than a threshold score, a new cluster count is determined for the plurality of data points, and the clustering operation is re-executed with the new cluster count, generating a second set of clusters. A combination of a within-cluster sum of squares (WCSS) analysis and a silhouette analysis may be executed on the cluster silhouette scores to determine the new cluster count. The new cluster silhouette scores are then computed for the second set of clusters. If all of the new cluster silhouette scores are equal to or greater than the threshold score, the newly generated clusters may correspond to have optimal cohesion and separation of data points within them. Such clusters can then be utilized for various operations. For example, if the data points correspond to business rules associated with a code block of a legacy system and each cluster corresponds to an entity associated with the code block, the newly generated clusters can be utilized to generate various system architecture elements in conformity with the entities and the business rules. The system architecture elements may correspond to user interfaces, back-end processing logic, databases, tables, or the like.

The present disclosure thus enables a clustering technique to group data points (e.g., business rules) into clusters that represent coherent entities, which can then be used to generate system architecture elements in alignment with the associated business rules. By incorporating a density function into the computation of silhouette scores, the clustering technique becomes more robust and adaptable to various types of data and clusters. Additionally, the integration of the density function enhances the ability to capture the cohesion and separation of data points, particularly in clusters with irregular shapes or varying densities. This adaptation provides a more nuanced evaluation of cluster quality, resulting in better clustering outcomes for complex datasets that conventional techniques may fail to analyze effectively. The application area of the present disclosure may include any domain where there is a need for clustering to find cohesion in the data. It is appreciated that the human mind is not equipped to determine an optimal number of clusters for clustering data points associated with clusters of irregular shapes or varying densities, given the digital interconnectedness of such data clustering.

### FIG. DESCRIPTION

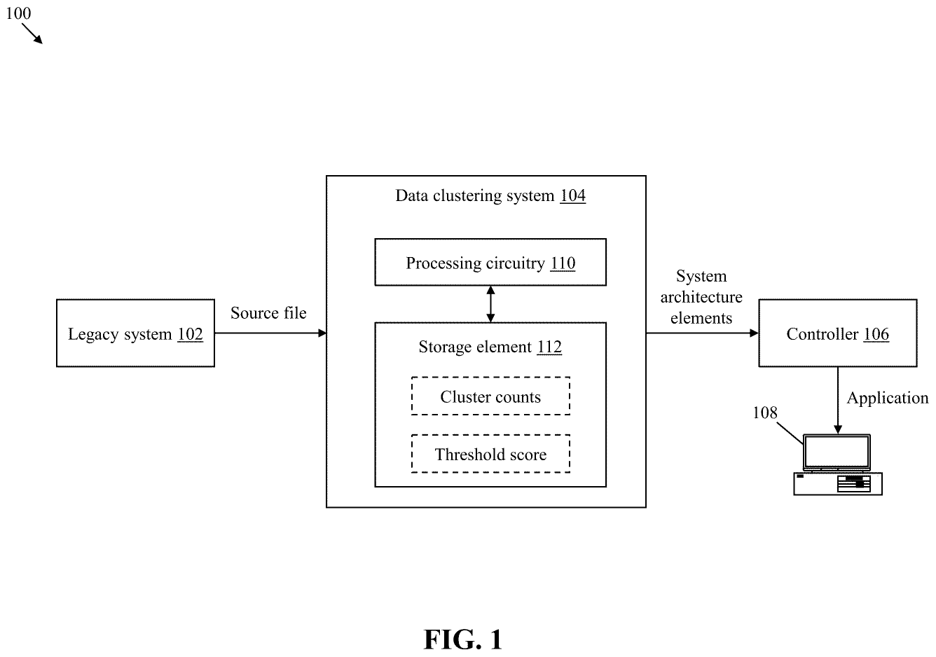

FIG. 1 is a schematic diagram that illustrates an environment 100 for data clustering using density-based silhouette scores, consistent with disclosed embodiments of the present disclosure.

Data clustering is a key technique for grouping similar data points and is widely implemented in legacy business systems like inventory management, supply chain optimization, and customer relationship management. The primary goal of data clustering is to ensure that points within each cluster are more alike than those in different clusters. However, many traditional clustering approaches lack robust evaluation metrics, often assuming clusters are convex and uniformly dense, a premise that rarely holds true in practice, as clusters can have arbitrary shapes and varying densities. This mismatch can lead to misclassification, improper cohesion and separation within the clusters, and poorly defined boundaries, ultimately resulting in inaccurate analyses and misinformed decisions.

To overcome these challenges, a data clustering technique is disclosed in the present disclosure. The environment 100 of the present disclosure may include a legacy system 102, a data clustering system 104, a controller 106, and an external system 108. The legacy system 102 may be implemented in a variety of computing systems, such as a mainframe computer, a server, a network server, a laptop computer, a desktop computer, a notebook, a workstation, or the like. The legacy system 102 may have a source file associated therewith. In a non-limiting example, the source file may correspond to a code block associated with the legacy system 102.

The data clustering system 104 may be configured to execute the data clustering technique of the present disclosure. The data clustering technique of the present disclosure uses density-based silhouette scores for data clustering. To implement the data clustering technique of the present disclosure, the data clustering system 104 may include processing circuitry 110 and a storage element 112. The storage element 112 may correspond to hardware storage (for example, hard drive, solid-state drive, or the like) or cloud storage (for example, cloud services).

The processing circuitry 110 may be coupled to the legacy system 102 and the storage element 112. The processing circuitry 110 may include suitable logic, circuitry, interfaces, and/or code, executable by the circuitry, that may be configured to execute the data clustering technique of the present disclosure. For example, the processing circuitry 110 may be configured to receive the source file from the legacy system 102. The processing circuitry 110 may further be configured to extract a plurality of data points from the source file. The plurality of data points may correspond to a plurality of business rules associated with the code block. Further, the processing circuitry 110 may be configured to execute a clustering operation on the plurality of data points. In a non-limiting example, the clustering operation may correspond to one of a k-means clustering operation, a density-based spatial clustering of applications with noise (DBSCAN) operation, a divisive hierarchical clustering operation, or a spectral clustering operation. In an embodiment, to execute the clustering operation on the plurality of data points, the processing circuitry 110 may be configured to transform the plurality of data points into a plurality of embedding vectors. Each embedding vector may represent a distinct data attribute of the legacy system 102. The processing circuitry 110 may transform the plurality of data points into the plurality of embedding vectors based on a Universal Sentence Encoder (USE) technique. In an example, an embedding vector may define a data attribute by representing a characteristic of the legacy system 102, such as a business rule, a security policy, a system configuration, within a high-dimensional vector space, or the like.

The processing circuitry 110 may execute the clustering operation on the plurality of data points based on a first cluster count. The storage element 112 may be configured to store the first cluster count, and the processing circuitry 110 may be further configured to retrieve the first cluster count from the storage element 112 to execute the clustering operation. Further, the processing circuitry 110 may execute the clustering operation on the plurality of data points to generate a first plurality of clusters. A number of clusters in the first plurality of clusters may be equal to the first cluster count. The first cluster count may refer to an initial number of clusters selected for the clustering operation. For example, the first cluster count may serve as an input parameter to the clustering operation, ensuring that the data points are partitioned into a number of clusters equal to the first cluster count. Further, each cluster of the plurality of clusters may include a cluster comprising a set of embedding vectors corresponding to a set of data points. For example, the first plurality of clusters may include a first cluster comprising a first set of data points of the plurality of data points. In an embodiment, the first cluster may include a first set of embedding vectors, of the plurality of embedding vectors, corresponding to the first set of data points.

For clarity and brevity, it is understood that, unless otherwise specified, the term “plurality of data points,” as used hereinafter, may refer to embedding vectors derived from the plurality of data points, as described in the preceding sections. The term “data point” is intended to include, and shall be construed as, the corresponding embedding vector, which represents a distinct data attribute of the legacy system 102. In a non-limiting example, the data attributes may correspond to business rules, security policies, system configurations, or a combination thereof.

The processing circuitry 110 may further be configured to determine, for a first data point of the first set of data points, a first density score that is indicative of a number of data points in the first cluster within a predefined range from the first data point. For example, the first density score may indicate whether the first data point is densely or sparsely populated in relation to other data points in the first set of data points. The processing circuitry 110 may determine the first density score for the first data point using a k-nearest neighbors' technique.

The processing circuitry 110 may further be configured to determine, for the first data point, based on the first density score, a first set of weighted distances. The first set of weighted distances may be between the first data point and other data points of the first cluster. For example, a first weighted distance may be determined between the first data point and a second data point of the first set of data points. In an example, the second data point may refer to any data point within the first set of data points other than the first data point. To determine the first weighted distance between the first data point and the second data point, the processing circuitry 110 may be further configured to determine a first distance between the first data point and the second data point and adjust the first distance based on the first density score. The adjusted first distance may correspond to a product of the first distance and the first density score. In an example, the first distance between the first data point and the second data point may correspond to a Euclidian distance. In a similar manner as described above, the processing circuitry 110 may determine other weighted distances (for example, other than the first weighted distance) of the first set of weighted distances.

The processing circuitry 110 may be configured to generate a first intra-cluster distance for the first data point. In an embodiment, the processing circuitry 110 may be configured to generate the first intra-cluster distance based on the first set of weighted distances. In an example, the first intra-cluster distance may correspond to an average of the first set of weighted distances.

The processing circuitry 110 may further be configured to determine a set of distances between the first data point and a second set of data points of a second cluster of the plurality of clusters. The second cluster may be a k-nearest neighbor of the first cluster. The processing circuitry 110 may be configured to generate a first inter-cluster distance for the first data point. In an embodiment, the processing circuitry 110 may be configured to generate the first inter-cluster distance based on the set of distances. In an example, the first inter-cluster distance may correspond to an average of the set of distances.

The processing circuitry 110 may be further configured to generate a first set of silhouette scores for the first set of data points, with a first silhouette score generated for the first data point. The first silhouette score for the first data point may be generated based on the first density score, the first intra-cluster distance (e.g., the first set of weighted distances), and the first inter-cluster distance.

Other silhouette scores of the first set of silhouette scores for other data points of the first set of data points may be generated in a manner similar to the generation of the first silhouette score. For example, in a similar manner as described above, the processing circuitry 110 may also be configured to determine density scores for remaining data points (for example, other than the first data point) in the first set of data points within the first cluster. Additionally, the processing circuitry 110 may be configured to determine sets of weighted distances (hereinafter referred to as weighted distances), and in turn, intra-cluster distances for other data points within the first cluster in a similar manner as described above. Further, the processing circuitry 110 may be configured to determine inter-cluster distances for other data points within the first cluster in a similar manner as described above. Lastly, for each data point, a silhouette score is generated based on a corresponding density score, a corresponding intra-cluster distance, and a corresponding inter-cluster distance.

The processing circuitry 110 may be further configured to compute a first cluster silhouette score for the first cluster based on the first set of silhouette scores. In an example, the first cluster silhouette score for the first cluster may correspond to an average of the first set of silhouette scores generated for the first set of data points of the first cluster. Similarly, the processing circuitry 110 may be configured to compute a cluster silhouette score for each remaining cluster of the first plurality of clusters in a manner similar to the computation of the first cluster silhouette score for the first cluster. Thus, the processing circuitry 110 may be configured to compute a first plurality of cluster silhouette scores for the first plurality of clusters, with the first cluster silhouette score computed for the first cluster.

The clustering of the plurality of data points is controlled based on the first plurality of cluster silhouette scores. For example, the processing circuitry 110 may be configured to compare each of the first plurality of cluster silhouette scores with a threshold score. The storage element 112 may be configured to store the threshold score. In an embodiment, the threshold score may be fixed and may be determined based on domain expertise and empirical analysis of cluster coherence. Further, in several embodiments, the threshold score may be dynamically adjusted based on the inter-cluster distance (e.g., the threshold score increases if the clusters are separated), the intra-cluster density (e.g., the threshold score reduces if the clusters are dense and compact), or the like. In an example, for customer segmentation, the threshold score may be adjusted based on customer spending behavior patterns. The threshold score may be defined such that cluster silhouette scores (for example, silhouette scores of clusters) less than the threshold score indicate that the separation of data points within the respective clusters is suboptimal. In an example, the threshold score may be equal to 0.7. However, in other embodiments, the threshold score may be different. The processing circuitry 110 may be further configured to retrieve the threshold score from the storage element 112 to perform the comparison.

For the sake of ongoing discussion, it is assumed that at least one of the first plurality of cluster silhouette scores is less than the threshold score. In response to at least one of the first plurality of cluster silhouette scores being less than the threshold score, the processing circuitry 110 may be further configured to determine a second cluster count for the clustering operation. The second cluster count may be determined based on the first plurality of cluster silhouette scores. In an embodiment, the processing circuitry 110 may be configured to execute a combination of a within-cluster sum of squares (WCSS) analysis and a silhouette analysis on the first plurality of cluster silhouette scores to determine the second cluster count. The processing circuitry 110 may be further configured to store the second cluster count in the storage element 112.

The processing circuitry 110 may be further configured to re-execute, based on the second cluster count, the clustering operation on the plurality of data points to generate a second plurality of clusters. A number of clusters in the second plurality of clusters may be equal to the second cluster count. The processing circuitry 110 may be further configured to compute a second plurality of cluster silhouette scores for the second plurality of clusters. The second plurality of cluster silhouette scores may be computed in a manner similar to the computation of the first plurality of cluster silhouette scores.

The processing circuitry 110 may be further configured to compare each of the second plurality of cluster silhouette scores with the threshold score. If any of the second plurality of cluster silhouette scores is less than the threshold score, a third cluster count may be determined and the aforementioned process may be repeated. Conversely, if each of the second plurality of cluster silhouette scores is equal to or greater than the threshold score, the second plurality of clusters may correspond to have optimal cohesion and separation of data points within them. The increased cluster silhouette scores indicate that corresponding clusters represent a cohesive set of functionalities that can be developed, deployed, and scaled independently. Thus, such clusters can then be utilized for various operations. The clustering of the plurality of data points is thus controlled based on the cluster silhouette scores.

In the example of the legacy system 102 described in FIG. 1, the plurality of data points may correspond to the plurality of business rules associated with the code block of the legacy system 102. Further, each cluster, of the second plurality of clusters, includes a set of business rules of the plurality of business rules, and corresponds to an entity associated with the code block. In such a scenario, the processing circuitry 110 may be further configured to generate, in response to each of the second plurality of cluster silhouette scores being equal to or greater than the threshold score, one or more system architecture elements based on the second plurality of clusters. The one or more system architecture elements may be generated in conformity with the entity and the set of business rules associated with each cluster of the second plurality of clusters. In an example, the one or more system architecture elements may include essential components of a modern technology stack such as microservices, micro-frontend screens, classes, database tables, or the like. The micro-frontend screens may be user interface components designed for a distributed front-end architecture, whereas classes and database tables may include backend logic and data structures aligned with the modernized application architecture. In an embodiment, the microservices are developed based on the defined clusters, adhering to microservices principles like loose coupling and high cohesion.

The controller 106 may be coupled to the data clustering system 104 (e.g., the processing circuitry 110) and the external system 108. The controller 106 may include suitable logic, circuitry, interfaces, and/or code, executable by the circuitry, that may be configured to receive the one or more system architecture elements from the data clustering system 104 (e.g., the processing circuitry 110). The controller 106 may be further configured to process the one or more system architecture elements and engineer a new application in accordance with modern programming languages based on the one or more system architecture elements. A codebase of the engineered application may differ from a codebase of the code block of the legacy system 102. The controller 106 may be further configured to render the engineered application on the external system 108. The external system 108 may correspond to a cellphone, a laptop, a tablet, a phablet, a desktop, a computer, or the like.

In some embodiments, the controller 106 may be further configured to test the application. The testing of the application may include unit, integration, or end-to-end testing. In several embodiments, the controller 106 may be further configured to monitor the performance of the application using monitoring tools to track metrics like response time, throughput, and error rates. Based on the monitoring data, the controller 106 may be further configured to optimize and refactor the application as needed to improve performance and scalability. This may involve improving the code, optimizing the database queries, or scaling the microservices to handle increased load. The seamless transition from legacy business logic to modern software architecture minimizes errors, improves maintainability, and accelerates the modernization process.

Although FIG. 1 describes the implementation of the data clustering technique for the generation of one or more system architecture elements from the plurality of business rules, the scope of the present disclosure is not limited. In several embodiments, the data clustering technique of the present disclosure may be implemented in different applications without deviating from the scope of the present disclosure. For example, the data clustering technique of the present disclosure may be implemented in recommendation engines on over-the-top (OTT) platforms, fraud detection (e.g., detecting anomalies in transaction clusters), or the like.

The data clustering technique may enhance the recommendation engines on the OTT platforms by ensuring more accurate and meaningful clustering of users or content based on viewing patterns. The data clustering technique may improve cluster shape detection by accommodating irregularly shaped clusters (e.g., niche content preferences) instead of forcing clusters into spherical shapes. In fraud detection use cases, the data clustering technique of the present disclosure may refine clustering accuracy, helping to identify fraudulent patterns within legitimate behaviors. Specifically, the data clustering technique of the present disclosure aids in detecting anomalies in transaction clusters, as fraudulent transactions often form dense, irregular clusters within legitimate data. The data clustering technique of the present disclosure accurately evaluates these cluster shapes, highlighting suspicious groupings.

The present disclosure thus enables a data clustering technique to group data points (e.g., business rules) into clusters that represent coherent entities, which can then be used to generate system architecture elements in alignment with the associated business rules. By incorporating a density function into the computation of silhouette scores, the data clustering technique of the present disclosure becomes more robust and adaptable to various types of data and clusters. Additionally, the integration of the density function enhances the ability to capture the cohesion and separation of data points, particularly in clusters with irregular shapes or varying densities. This adaptation provides a more nuanced evaluation of cluster quality, resulting in better clustering outcomes for complex datasets that conventional techniques may fail to analyze effectively.

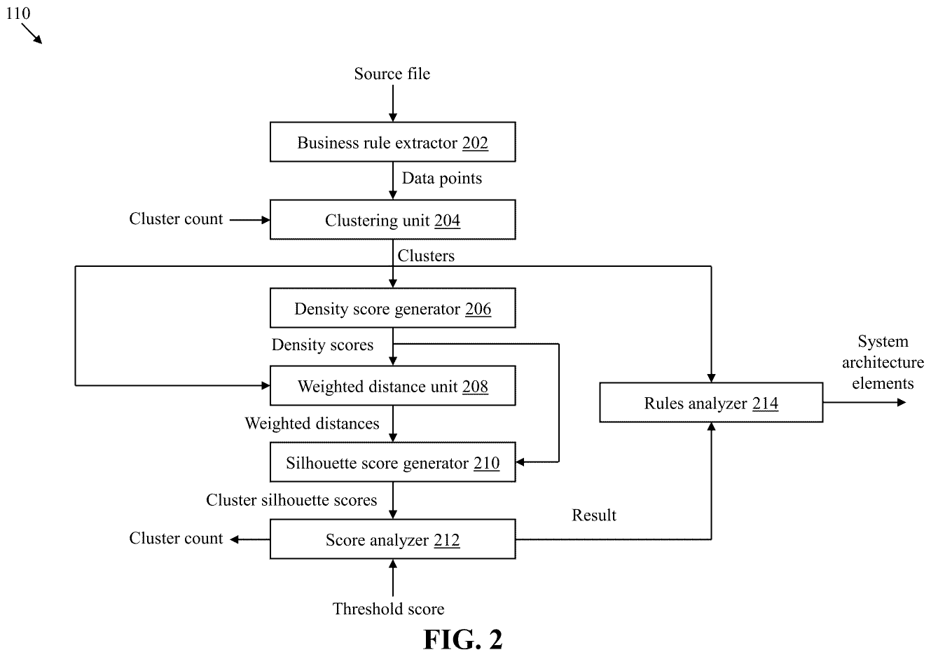

FIG. 2 is a block diagram of the processing circuitry 110, consistent with disclosed embodiments of the present disclosure. As illustrated in FIG. 2, the processing circuitry 110 may include a business rule extractor 202, a clustering unit 204, a density score generator 206, a weighted distance unit 208, a silhouette score generator 210, a score analyzer 212, and a rules analyzer 214.

The business rule extractor 202 may be coupled to the legacy system 102. The business rule extractor 202 may include suitable logic, circuitry, interfaces, and/or code, executable by the circuitry, that may be configured to perform one or more operations. For example, the business rule extractor 202 may be configured to receive the source file from the legacy system 102 and extract the plurality of data points (e.g., the plurality of business rules) from the source file. In an example, the plurality of business rules may be represented as textual data. In an embodiment, the business rule extractor 202 may be configured to pre-process the textual data to cleanse, normalize, and/or prepare the textual data for subsequent analysis. To pre-process the textual data, the business rule extractor 202 may be configured to convert the textual data to lowercase to maintain consistency, and remove punctuation marks and commonly occurring words from the textual data. Additionally, the business rule extractor 202 may decompose the textual data into individual words and group different forms of the same word together.

The clustering unit 204 may be coupled to the business rule extractor 202 and the storage element 112. The clustering unit 204 may include suitable logic, circuitry, interfaces, and/or code, executable by the circuitry, that may be configured to perform one or more operations. For example, the clustering unit 204 may be configured to receive, from the business rule extractor 202, the plurality of data points. It is to be understood that the plurality of data points may correspond to the processed business rules. In an example, each business rule may represent a sentence. The clustering unit 204 may be configured to retrieve, from the storage element 112, the first cluster count. The clustering unit 204 may further be configured to execute the clustering operation on the plurality of data points based on the first cluster count. In a non-limiting example, the clustering operation may correspond to one of a k-means clustering operation, a DBSCAN operation, a divisive hierarchical clustering operation, or a spectral clustering operation. For example, in the k-means clustering operation, each data point (e.g., sentence embedding) may be assigned to the nearest cluster by minimizing the distance between the data point and the cluster's centroid. Further, the centroids of the clusters are recalculated based on the current cluster memberships, aiming to minimize the within-cluster sum of squares (e.g., variance). Cluster membership may refer to an assignment of data points to a specific cluster based on their similarity to the centroid of the cluster.

To execute the clustering operation on the plurality of data points, the clustering unit 204 may be further configured to transform the plurality of data points into the plurality of embedding vectors. In an example, each embedding vector may represent a distinct data attribute of the legacy system 102. The clustering unit 204 may transform the plurality of data points into the plurality of embedding vectors based on a USE technique. In an embodiment, the clustering unit 204 may encode the business rules (e.g., sentences) into a corresponding vector representation, capturing the contextual nuances of the text. Each vector may represent a sentence in such a way that similar sentences have similar vector representations.

In an embodiment, the clustering unit 204 may execute the clustering operation on the plurality of data points for one or more cluster counts. For example, the clustering unit 204 may evaluate different cluster counts to determine an optimal number of clusters into which the plurality of data points may be divided. Initially, the clustering unit 204 may execute the clustering operation on the plurality of data points using the first cluster count. The first cluster count may refer to an initial number of clusters selected for the clustering operation.

In response to executing the clustering operation on the plurality of data points based on the first cluster count, the clustering unit 204 may generate the first plurality of clusters. The clustering results may be used to label each sentence with a cluster identifier, indicating which group/cluster a particular sentence belongs to. Herein the term ‘cluster identifier’ refers to a unique label assigned to a specific cluster of data points, distinguishing it from other clusters. This allows for an analysis of the thematic or topical consistency within each cluster, facilitating an understanding of the underlying patterns or themes in the data.

The density score generator 206 may be coupled to the clustering unit 204. The density score generator 206 may include suitable logic, circuitry, interfaces, and/or code, executable by the circuitry, that may be configured to perform one or more operations. For example, the density score generator 206 may be configured to receive the first plurality of clusters from the clustering unit 204. The density score generator 206 may be configured to determine the first density score for the first data point within the first cluster. The first density score may indicate whether the first data point is densely or sparsely populated in relation to other data points in the first cluster. A high first density score (for example, equal to or greater than a predefined value) may indicate that the first data point is densely populated, with a large number of neighboring data points in the vicinity. A low first density (for example, less than the predefined value) score may indicate that the first data point is sparsely populated, with few or no neighboring data points in the vicinity. In a similar manner as described above, the density score generator 206 may also be configured to determine density scores for remaining data points (for example, other than the first data point) in the first cluster, as well as for data points in other clusters within the first plurality of clusters.

The weighted distance unit 208 may be coupled to the density score generator 206. The weighted distance unit 208 may include suitable logic, circuitry, interfaces, and/or code, executable by the circuitry, that may be configured to perform one or more operations. For example, the weighted distance unit 208 may be configured to receive the density scores of the data points corresponding to the first plurality of clusters from the density score generator 206. For each data point, the weighted distance unit 208 may be further configured to determine a distance between the corresponding data point and each other data point within the same cluster and adjust the determined distance based on the density score generated for the corresponding data point. In an example, the determined distance may correspond to a Euclidian distance. Further, the adjusted distance may correspond to a product of the determined distance and the density score. The adjusted distances for a first set of distances between the first data point and other data points of the first cluster may correspond to a first set of weighted distances for the first data point. The first set of weighted distances may thus indicate a degree of compactness of the first data point within the first cluster. In a similar manner as described above, weighted distances for other data points within the first cluster and for data points in other clusters within the first plurality of clusters may be determined.

The silhouette score generator 210 may be coupled to the weighted distance unit 208. The silhouette score generator 210 may include suitable logic, circuitry, interfaces, and/or code, executable by the circuitry, that may be configured to perform one or more operations. For example, the silhouette score generator 210 may be configured to receive the weighted distances corresponding to the data points within the first plurality of clusters from the weighted distance unit 208. The silhouette score generator 210 may be configured to generate an intra-cluster distance for each data point based on the corresponding set of weighted distances (e.g., an average of the corresponding set of weighted distances). The silhouette score generator 210 may be configured to determine a set of distances between each data point of one cluster and data points of a neighboring cluster of the plurality of clusters. In an example, the neighboring cluster may be the k-nearest neighbor. Further, the silhouette score generator 210 may be configured to determine an inter-cluster distance for each data point based on the corresponding set of distances (e.g., an average of the corresponding set of distances).

The silhouette score generator 210 may be configured to generate a first set of silhouette scores for the first set of data points such that the first silhouette score for the first data point is generated based on the first density score, the first inter-cluster distance, and the first intra-cluster distance. The first silhouette score may indicate the similarity of the first data point to the assigned cluster compared to the similarity with other clusters.

In an example, the silhouette score for a data point may range from an integer value of negative (−1) to positive (+1). A silhouette score close to +1 may indicate that the data point is well-matched to its assigned cluster and poorly matched to neighboring clusters, suggesting high cohesion and well-defined separation between clusters. A silhouette score near 0 may indicate that the data point is near the decision boundary between neighboring clusters, indicating that the data point is equally close to two different clusters. A silhouette score close to −1 may indicate that the data point is misclassified, as the data point is closer to a neighboring cluster than to the assigned cluster, reflecting poor cohesion and separation within the clusters.

In an embodiment, the silhouette score generator 210 may generate a silhouette score for a data point (also referred to as density-based silhouette score) based on Equation (1) provided below.

$$S\_d = \frac{( b\_i - a\_i * d\_i )}{max ( b\_i , a\_i * d\_i )} \qquad ( 1 )$$

where,
S_d represents the density-based silhouette score for the data point,
a_i represents an intra-cluster distance,
b_i represents an inter-cluster distance, and
d_i represents a density score.

In an embodiment, the silhouette score generator 210 may compute the first plurality of cluster silhouette scores for the first plurality of clusters. The first cluster silhouette score of the first cluster corresponds to an average of the first set of silhouette scores of the first set of data points of the first cluster.

In an example, the first cluster silhouette score of ‘+1’ may indicate good clustering, where the data points are well-clustered and distinctly separated from other clusters. The first cluster silhouette score close to ‘0’ may suggest that the data points are near the decision boundary between clusters, implying that the clusters are not clearly defined. Further, the first cluster silhouette score close to ‘−1’ may indicate poor clustering, where data points are misclassified and closer to neighboring clusters than their cluster, reflecting poor separation and cohesion.

The score analyzer 212 may be coupled to the silhouette score generator 210. The score analyzer 212 may include suitable logic, circuitry, interfaces, and/or code, executable by the circuitry, that may be configured to perform one or more operations. For example, the score analyzer 212 may be configured to receive the first plurality of cluster silhouette scores from the silhouette score generator 210. The score analyzer 212 may be configured to compare each of the first plurality of cluster silhouette scores with the threshold score. In an embodiment, the score analyzer 212 may compare each of the first plurality of cluster silhouette scores with the threshold score to determine whether any of the first plurality of cluster silhouette scores is less than the threshold score.

Based on the comparison, the score analyzer 212 may generate a result indicative of whether any of the first plurality of cluster silhouette scores is less than the threshold score. If any of the first plurality of cluster silhouette scores is less than the threshold score, the result may suggest that the determined first cluster count is incorrect. In such a scenario, the score analyzer 212 may be further configured to determine the second cluster count for the clustering operation. In an embodiment, the score analyzer 212 may be configured to execute a combination of a WCSS analysis and a silhouette analysis on the first plurality of cluster silhouette scores to determine the second cluster count. The WCSS technique involves plotting the variance explained by the clusters against the number of clusters. It helps in identifying a point after which the marginal gain in explained variance diminishes significantly, suggesting an optimal number of clusters. The silhouette technique evaluates the consistency within clusters. A silhouette score near+1 indicates that the samples are far away from neighboring clusters, while a score near 0 indicates that the samples are close to the decision boundary of the neighboring clusters. The second cluster count may be greater than the first cluster count. The score analyzer 212 may be further configured to store the second cluster count in the storage element 112.

The aforementioned operations of the clustering unit 204, the density score generator 206, the weighted distance unit 208, and the silhouette score generator 210 are repeated based on the second cluster count, and the second plurality of cluster silhouette scores for the second plurality of clusters are computed. The score analyzer 212 may be further configured to compare each of the second plurality of cluster silhouette scores with the threshold score. If any of the second plurality of cluster silhouette scores is less than the threshold score, the result may suggest that the determined second cluster count is incorrect, and the aforementioned process may be repeated. However, if each of the second plurality of cluster silhouette scores is less than the threshold score, the result may suggest that the determined second cluster count is correct.

The rules analyzer 214 may be coupled to the score analyzer 212 and the clustering unit 204. The rules analyzer 214 may include suitable logic, circuitry, interfaces, and/or code, executable by the circuitry, that may be configured to perform one or more operations. For example, the rules analyzer 214 may be configured to receive the result from the score analyzer 212. Further, the rules analyzer 214 may be configured to receive the clusters (e.g., the first and second pluralities of clusters) from the score analyzer 212. In response to one of the first plurality of cluster silhouette scores being less than the threshold score, the rules analyzer 214 may not execute any action. Conversely, in response to each of the second plurality of cluster silhouette scores being equal to or greater than the threshold score, the rules analyzer 214 may be further configured to generate the one or more system architecture elements based on the second plurality of clusters.

Although it is described that the second plurality of cluster silhouette scores are equal to or greater than the threshold score, the scope of the present disclosure is not limited to it. In numerous embodiments, the cluster count may be updated multiple times until the corresponding cluster silhouette scores are equal to or greater than the threshold score.

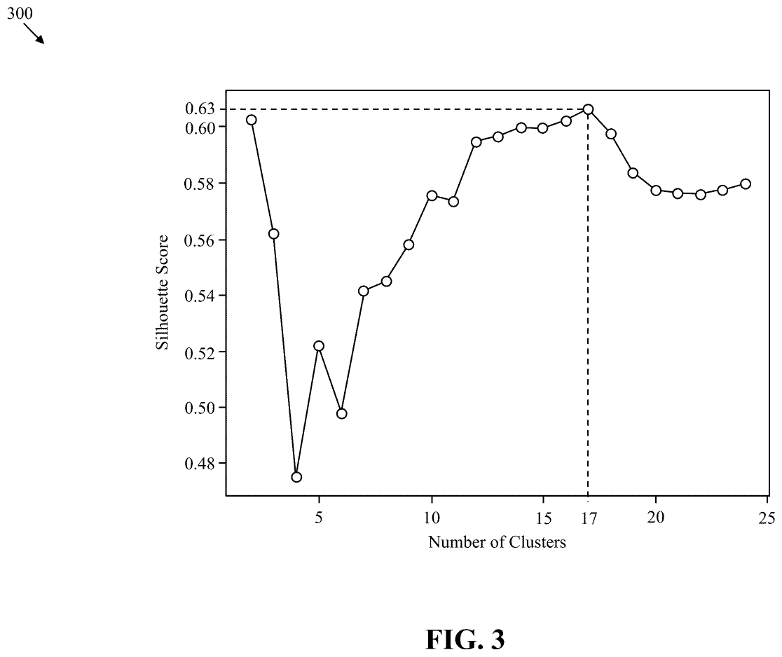

FIG. 3 depicts a cluster representation graph 300 that illustrates a cluster count determined based on conventional silhouette scores, consistent with disclosed embodiments of the present disclosure. In the present disclosure, the first cluster count may be determined using the conventional silhouette scores. The conventional silhouette scores may be determined based exclusively on the distance between data points, without taking density scores into consideration. In an example, the cluster representation graph 300 may be obtained from the WCSS analysis.

As shown in FIG. 3, the X-axis of the cluster representation graph 300 represents the number of clusters, while the Y-axis represents the corresponding silhouette score for each cluster. The cluster count corresponding to the maximum silhouette score is identified as optimal. As shown in the cluster representation graph 300, the maximum silhouette score (e.g., 0.63) is identified for the cluster count of 17.

In an example, the legacy system 102 may be associated with a loan application process. In such a scenario, the following business rules may be extracted from the code block of the legacy system 102.
“Must always precede the loan_disbursement_date.”,
“Cannot be a future date relative to the system's current date.”,
“Must be set to a working day; weekends or public holidays are invalid.”,
“Must occur within 30 days of the loan_approval_date.”,
“Delays require a reason logged in the system.”,
“Records older than 5 years must be flagged for archival.”,
“The date format should follow ISO 8601: YYYY-MM-DD.”,
“Must be captured as part of the loan approval workflow and cannot be updated post-approval.”,
“Must be one of the predefined statuses: ‘Pending’, ‘Approved’, ‘Rejected’, ‘Disbursed’, or ‘Closed’.”,
“The status ‘Closed’ should trigger archival of the loan record after 30 days.”,
“Descriptions exceeding 50 characters must be truncated automatically.”,
“Cannot be updated directly; transitions should follow a defined workflow.”,
“Loans without a loan_approval_date should not progress to the next stage.”,
“Must be alphanumeric and consist of exactly 12 characters.”,
“No two customers can share the same customer_unique_id within the database.”,
“Must not contain special characters or spaces.”,
“Loans with an overdue status should display the remaining_principal_amount prominently in customer communication.”,
“For loans refinanced or restructured, the remaining_principal_amount prominently in customer communications.”,
“System must validate that remaining_principal_amount matches the initial loan amount minus payments made.”,
“A reminder must be sent to the customer 7 days before the next_payment_due_date.”,
“Must be stored as a valid alphanumeric string with no special characters.”,
“Should match one of the predefined locations in the system's branch database.”,
“Branch locations must include city and state information for clarity.”,
“Verification must comply with the government-mandated KYC norms and guidelines.”,
“Customers with ‘Pending’ or ‘Rejected’ KYC status cannot proceed with loan disbursement.”,
“Loans with overdue payments should calculate penalty from the day after the due date.”,
“Changes to the due date must be approved by an authorized officer and logged for audit.”
“Loan ID must appear in all customer notifications and correspondences.”,
“System must ensure loan IDs are unique across branches.”,
“System-generated reports must include loan IDs as a key identifier.”

Further, as shown in the cluster representation graph 300, the first cluster count determined using the conventional silhouette scores is 17. Thus, the business rules may be clustered into 17 clusters (e.g., entities). For the abovementioned business rules, the following 17 entities can be determined:
“policy_date”,
“customer_id”,
“loan_id”,
“policy_number”,
“eligibility_amount”,
“interest_rate”,
“duration”,
“customer_name”,
“customer_address”,
“status”,
“policy_type”,
“loan_type”,
“transaction_date”,
“payment_due_date”,
“penalty_rate”,
“total_outstanding”,
“branch id”

For the sake of simplicity, the business rules of only three entities (e.g., “policy date”, “customer_id”, and “load_id”) are shown below:

```
“policy_date”:
  {“rules”:
    [“Must follow ISO 8601 format: YYYY-MM-DD.”,
    “Cannot be a future date.”,
    “Policy date must match the record in the insurer's database.”,
    “Changes to the policy date must be logged with justification and approver's ID.”,
    “Policy date cannot precede the customer's registration date.”]},
“customer_id”:
  {“rules”:
    [“Must be a unique alphanumeric identifier.”,
    “Customer ID must be consistent across all internal systems.”,
    “Cannot be reused even after the customer account is closed.”,
    “Change to customer ID are not permitted except in cases of errors correction.”,
    “Customer ID must be associated with at least one active policy or loan.”,
    “New customer IDs must be generated by the system and not manually assigned.”,
    “System must validate that the customer ID is not already in use during creation.”,
    “Customer ID must comply with the format defined by the organization (e.g., 3 letters
  followed by 6 digits).”]},
“loan_id”:
  {“rules”:
    [“ Must be a unique alphanumeric identifier.”,
    “Loan ID must link to one and only one customer ID.”,
    “Cannot be modified once assigned to a loan.”,
    “Loan ID must be auto-generated by the system.”,
    “System must verify that no duplicate loan IDs exist in the database.”,
    “Loan ID must be present on all associated loan documents.”,
    “Loan ID changes must be restricted and require senior management approval.”,
    “Loan IDs must follow the standard company format (e.g., ‘LN-’ followed by 8 digits).”,
    “Loan ID must be tied to one branch location in the system.”,
    “Loan ID must remain valid for the entire lifecycle of the loan.”,
    “Loan ID must appear in all customer notifications and correspondences.”,
    “System must ensure loan IDs are unique across branches.”,
    “System-generated reports must include loan IDs as a key identifier.”,
    “Loan ID cannot be reused after loan closure.”,
    “Loan ID must be included in the transaction history of the associated loan.”]}
```

As conventional silhouette scores do not adequately capture the cohesion and separation of data points, particularly within irregularly shaped or densely populated clusters, the business rule clustering may be complex and/or non-uniform.

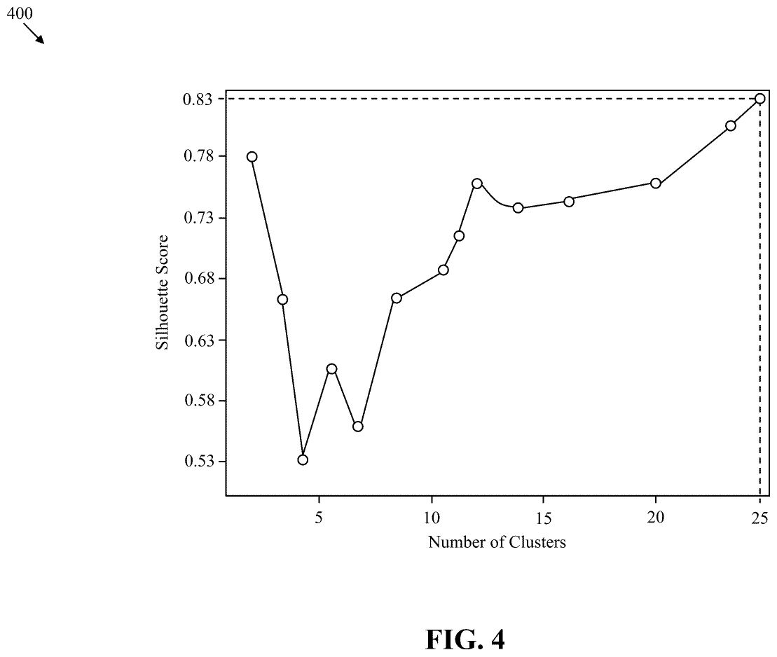

FIG. 4 depicts a cluster representation graph 400 that illustrates a cluster count determined based on density-based silhouette scores (for example, the second plurality of cluster silhouette scores), consistent with disclosed embodiments of the present disclosure.

As shown in FIG. 4, the X-axis of the cluster representation graph 400 represents the number of clusters, while the Y-axis represents the corresponding silhouette score for each cluster. The cluster count corresponding to the maximum silhouette score is identified as optimal. As shown in the cluster representation graph 400, the maximum silhouette score (e.g., 0.83) is identified for the cluster count of 25. The density-based silhouette scores may capture the cohesion and separation of data points within irregularly shaped and densely populated clusters. This results in more precise and reliable clustering outcomes.

The same business rules extracted from the code block of the legacy system 102 may now be clustered into 25 clusters (e.g., entities). For the abovementioned business rules, the following 25 entities can be determined:
“policy_start_date”,
“policy_end_date”,
“policy_due_date”,
“customer_unique_id”,
“loan_reference_id”,
“loan_approval_date”,
“loan_disbursement_date”,
“customer_full_name”,
“customer_email”,
“customer_contact_number”,
“loan_status_description”,
“policy_renewal_date”,
“loan_sub_type”,
“transaction_reference_id”,
“last_payment_date”,
“next_payment_due_date”,
“penalty_end_date”,
“total_interest_paid”,
“remaining_principal_amount”,
“branch_location”,
“branch_manager_id”,
“loan_closure_date”,
“customer_kyc_status”,
“loan moratorium period”

For the sake of simplicity, business rules of only four entities (e.g., “customer_unique_id”, “loan_reference_id”, “loan_approval_date”, and “load_disbursement_date”) are shown below:

```
“customer_unique_id”:
  “rules”:
    [“Must be alphanumeric and consist of exactly 12 characters.”,
    “No two customers can share the same customer_unique_id within the database.”,
    “Must not contain special characters or spaces.”,
    “Validation checks should ensure compliance with the format: ABC123456789.”,
    “Duplicates should trigger a flag and halt the transaction.”,
    “This field is case-insensitive when checked for duplicates.”]},
“loan_reference_id”:
  {“rules”:
    [“Should be generated automatically in the format: LOAN-YYYYMMDD-XXXX,
  where XXXX is a unique numeric identifier.”,
    “Must remain immutable once assigned to a loan.”,
    “If a loan is canceled or closed, the loan_reference_id must be retained for audit
  purposes.”,
    “Each loan_reference_id must be unique across all loans in the system.”,
    “Any invalid or missing loan_reference_id should trigger an error and require
  administrative intervention.”,
    “The system should log the creation timestamp of each loan_reference_id.”]},
“loan_approval_date”:
  {“rules”:
    [“Must always precede the loan_disbursement_date.”,
    “Cannot be a future date relative to the system's current date.”,
    “Records older than 5 years must be flagged for archival.”,
    “The date format should follow ISO 8601: YYYY-MM-DD.”,
    “Must be captured as part of the loan approval workflow and cannot be updated post-
  approval.”,
    “Loans without a loan_approval_date should not progress to the next stage.”]},
“loan_disbursement_date”:
  {“rules”:
    [“Must be set to a working day; weekends or public holidays are invalid.”,
    “Must occur within 30 days of the loan_approval_date.”,
    “Delays require a reason logged in the system.”,
    “Must not be earlier than the loan_approval_date.”,
    “Automated reminders should be sent 3 days before the scheduled
  loan_disbursement_date.”,
    “Disbursement dates for loans exceeding $100,000 must be approved by a senior
  manager.”]}
```

Thus, the clusters generated using density-based silhouette scores exhibit enhanced performance compared to the clusters generated using conventional silhouette scores. Specifically, the clusters generated using conventional silhouette scores are unable to effectively capture the complex structure of the data. In contrast, the clusters generated using density-based silhouette scores more accurately reflect the true distribution and relationships within the data. By integrating density scores into the silhouette score calculation, the data clustering technique of the present disclosure improves the cohesion and separation of data points within each cluster, resulting in more distinct and well-defined clusters. This improvement ensures that the newly formed clusters provide a more accurate representation of the data, thereby enabling more effective use in subsequent operations, such as generating system architecture elements that align with the associated business rules.

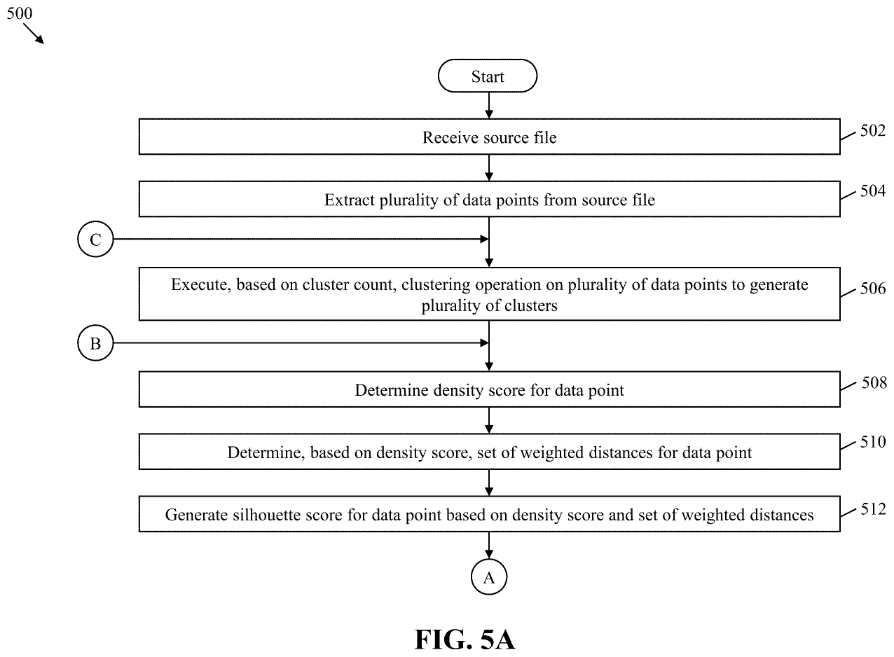

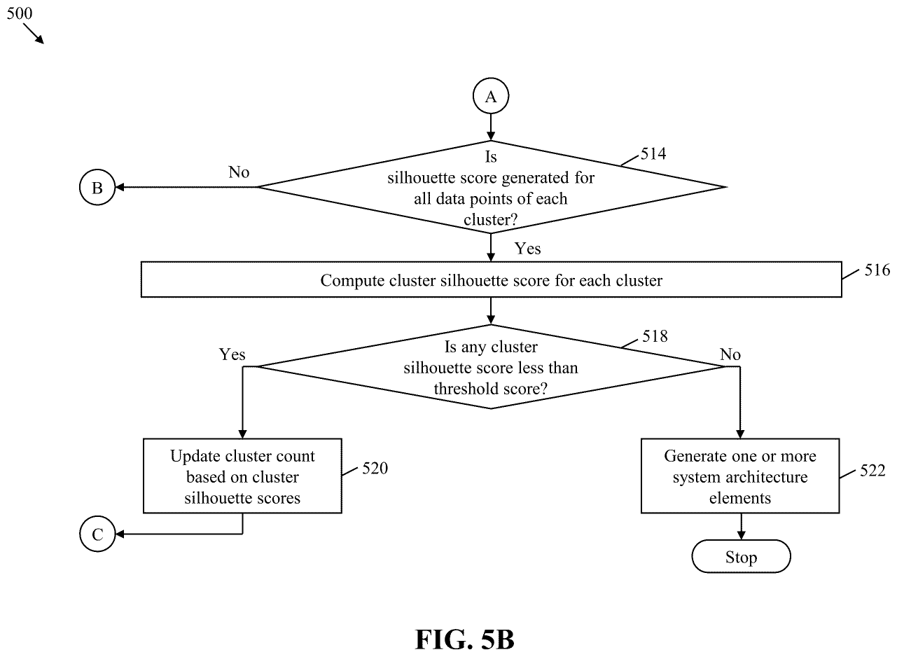

FIGS. 5A and 5B collectively, represents a flowchart 500 that illustrates a method for data clustering using density-based silhouette scores, consistent with disclosed embodiments of the present disclosure.

Referring to FIG. 5A, at 502, the processing circuitry 110 (e.g., the business rule extractor 202) may receive a source file. The source file may be associated with the legacy system 102. In an example, the source file may correspond to a code block of the legacy system 102. At 504, the processing circuitry 110 (e.g., the business rule extractor 202) may extract a plurality of data points from the source file. In an example, the plurality of data points may correspond to a plurality of business rules associated with the code block.

At 506, the processing circuitry 110 (e.g., the clustering unit 204) may execute, based on a cluster count, a clustering operation on the plurality of data points to generate a plurality of clusters. At 508, the processing circuitry 110 (e.g., the density score generator 206) may determine a density score for a data point. At 510, the processing circuitry 110 (e.g., the weighted distance unit 208) may determine, based on the density score, a set of weighted distances for the data point. At 512, the processing circuitry 110 (e.g., the silhouette score generator 210) may generate a silhouette score for the data point based on the density score and the set of weighted distances. The silhouette score may additionally be determined based on an inter-cluster distance associated with the data point.

Referring to FIG. 5B, at 514, the processing circuitry 110 (e.g., the silhouette score generator 210) may determine whether the silhouette score is generated for all data points of each cluster. If at 514, it is determined that the silhouette score for all data points of each cluster is not generated, 508 is executed again. In other words, 508-512 are repeated for all data points of all clusters. Conversely, if at 514, it is determined that silhouette scores are generated for all data points of all clusters, 516 is executed. At 516, the processing circuitry 110 (e.g., the silhouette score generator 210) may compute a cluster silhouette score for each cluster.

At 518, the processing circuitry 110 (e.g., the score analyzer 212) may determine if any cluster silhouette score is less than a threshold score. If at 518, it is determined that at least one cluster silhouette score is less than the threshold score, 520 is executed. At 520, the processing circuitry 110 (e.g., the score analyzer 212) may update the cluster count based on the cluster silhouette scores. 506 is then executed based on the updated cluster count. In other words, 506-518 are repeated for the updated cluster count. Conversely, if at 518, it is determined that all cluster silhouette scores are equal to or greater than the threshold score, 522 is executed. At 522, the processing circuitry 110 (e.g., the rules analyzer 214) may generate one or more system architecture elements. The system architecture elements may be generated based on the clusters of business rules.

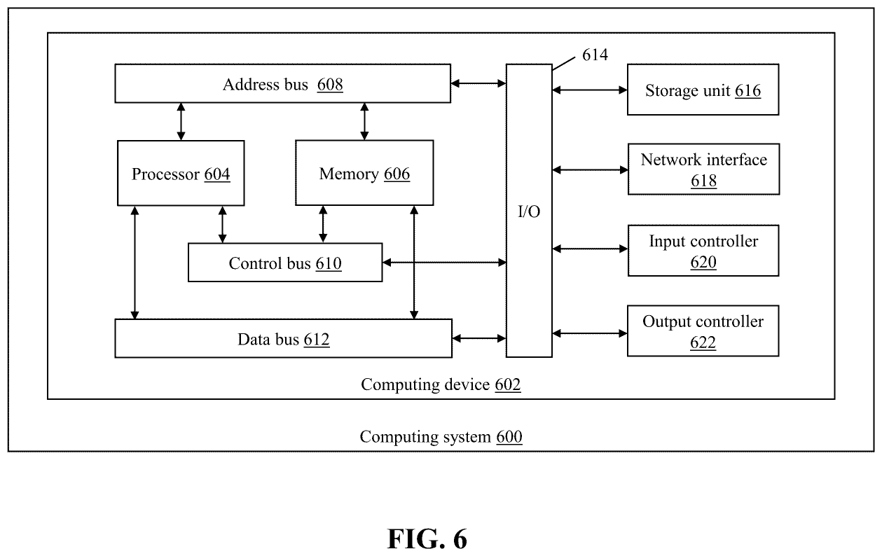

FIG. 6 shows an example computing system 600 for carrying out the methods of the present disclosure, consistent with disclosed embodiments of the present disclosure. Specifically, FIG. 6 shows a block diagram of an embodiment of the computing system 600 according to example embodiments of the present disclosure.

The computing system 600 may be configured to perform any of the operations disclosed herein. The computing system 600 may be implemented as a conventional computer system, an embedded controller, a laptop, a server, a mobile device, a smartphone, a customized machine, any other hardware platform, or any combination or multiplicity thereof. In one embodiment, the computing system 600 is a distributed system configured to function using multiple computing machines interconnected via a data network or bus system.

The computing system 600 includes computing devices (such as a computing device 602). The computing device 602 includes one or more processors (such as a processor 604) and a memory 606. The processor 604 may be any general-purpose processor(s) configured to execute a set of instructions. For example, the processor 604 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a state machine, gated logic, discrete hardware component, any other processing unit, or any combination or multiplicity thereof. In one embodiment, the processor 604 may be multiple processing units, a single processing core, multiple processing cores, special purpose processing cores, co-processors, or any combination thereof. The processor 604 may be communicatively coupled to the memory 606 via an address bus 608, a control bus 610, and a data bus 612.

The memory 606 may include non-volatile memories such as a read-only memory (ROM), a programable read-only memory (PROM), an erasable programmable read-only memory (EPROM), a flash memory, or any other device capable of storing program instructions or data with or without applied power. The memory 606 may also include volatile memories, such as a random-access-memory (RAM), a static random-access-memory (SRAM), a dynamic random-access-memory (DRAM), and a synchronous dynamic random-access-memory (SDRAM). The memory 606 may include single or multiple memory modules. While the memory 606 is depicted as part of the computing device 602, a person skilled in the art will recognize that the memory 606 may be separate from the computing device 602.

The memory 606 may store information that may be accessed by the processor 604. For instance, the memory 606 (e.g., one or more non-transitory computer-readable storage mediums, memory devices) may include computer-readable instructions (not shown) that may be executed by the processor 604. The computer-readable instructions may be software written in any suitable programming language or may be implemented in hardware. Additionally, or alternatively, the computer-readable instructions may be executed in logically and/or virtually separate threads on the processor 604. For example, the memory 606 may store instructions (not shown) that when executed by the processor 604 cause the processor 604 to perform operations such as any of the operations and functions for which the computing system 600 is configured, as described herein. Additionally, or alternatively, the memory 606 may store data (not shown) that may be obtained, received, accessed, written, manipulated, created, and/or stored. The data may include, for instance, the data and/or information described herein in relation to FIGS. 1-5. In some implementations, the computing device 602 may obtain from and/or store data in one or more memory device(s) that are remote from the computing system 600.

The computing device 602 may further include an input/output (I/O) interface 614 communicatively coupled to the address bus 608, the control bus 610, and the data bus 612. The data bus 612 may include a plurality of tunnels that may support communication in the environment 100. The I/O interface 614 is configured to couple to one or more external devices (e.g., to receive and send data from/to one or more external devices). Such external devices, along with the various internal devices, may also be known as peripheral devices. The I/O interface 614 may include both electrical and physical connections for operably coupling the various peripheral devices to the computing device 602. The I/O interface 614 may be configured to communicate data, addresses, and control signals between the peripheral devices and the computing device 602. The I/O interface 614 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, FireWire, various video buses, and the like. The I/O interface 614 is configured to implement only one interface or bus technology. Alternatively, the I/O interface 614 is configured to implement multiple interfaces or bus technologies. The I/O interface 614 may include one or more buffers for buffering transmissions between one or more external devices, internal devices, the computing device 602, or the processor 604. The I/O interface 614 may couple the computing device 602 to various input devices, including touch screens, scanners, biometric readers, electronic digitizers, receivers, touchpads, cameras, keyboards, any other pointing devices, or any combinations thereof. The I/O interface 614 may couple the computing device 602 to various output devices, including printers, projectors, tactile feedback devices, automation control, robotic components, actuators, transmitters, signal emitters, lights, and so forth.

The computing system 600 may further include a storage unit 616, a network interface 618, an input controller 620, and an output controller 622. The storage unit 616, the network interface 618, the input controller 620, and the output controller 622 are communicatively coupled to the central control unit (e.g., the memory 606, the address bus 608, the control bus 610, and the data bus 612) via the I/O interface 614. The network interface 618 communicatively couples the computing system 600 to one or more networks such as wide area networks (WAN), local area networks (LAN), intranets, the Internet, wireless access networks, wired networks, mobile networks, telephone networks, optical networks, or combinations thereof. The network interface 618 may facilitate communication with packet-switched networks or circuit-switched networks which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 616 is a computer-readable medium, preferably a non-transitory computer-readable medium, comprising one or more programs, the one or more programs comprising instructions which when executed by the processor 604 cause the computing system 600 to perform the method steps of the present disclosure. Alternatively, the storage unit 616 is a transitory computer-readable medium. The storage unit 616 may include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 616 stores one or more operating systems, application programs, program modules, data, or any other information. The storage unit 616 is part of the computing device 602. Alternatively, the storage unit 616 is part of one or more other computing machines that are in communication with the computing device 602, such as servers, database servers, cloud storage, network attached storage, and so forth.

The input controller 620 may include suitable logic, circuitry, interfaces, and/or code, executable by the circuitry, that may be configured to control one or more input devices that may be configured to receive source files. The output controller 622 may include suitable logic, circuitry, interfaces, and/or code, executable by the circuitry, that may be configured to control one or more output devices that may be configured to output clustering results, system architecture elements, or engineered applications.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems and methods for data clustering using density-based silhouette scores. While various embodiments of the disclosed systems and methods have been described above, they have been presented for purposes of example only, and not limitations. It is not exhaustive and does not limit the present disclosure to the precise form disclosed. Modifications and variations are possible considering the above teachings or may be acquired from practicing the present disclosure, without departing from the breadth or scope.

1. A system, comprising:
processing circuitry configured to:
execute, based on a first cluster count, a clustering operation on a plurality of data points to generate a first plurality of clusters, with a first cluster comprising a first set of data points, of the plurality of data points;
determine, for a first data point of the first set of data points, a first density score that is indicative of a number of data points in the first cluster within a predefined range from the first data point;
determine, for the first data point, based on the first density score, a first set of weighted distances, with a first weighted distance being determined between the first data point and a second data point of the first set of data points, wherein the first weighted distance is determined by determining a first distance between the first data point and the second data point, and adjusting the first distance based on the first density score;
generate a first set of silhouette scores for the first set of data points, with a first silhouette score for the first data point generated based on the first density score and the first set of weighted distances; and
compute a first plurality of cluster silhouette scores for the first plurality of clusters, with a first cluster silhouette score for the first cluster computed based on the first set of silhouette scores, wherein the clustering of the plurality of data points is controlled based on the first plurality of cluster silhouette scores.

2. The system of claim 1, wherein a number of clusters in the first plurality of clusters is equal to the first cluster count.

3. The system of claim 1, wherein the clustering operation corresponds to one of a k-means clustering operation, a density-based spatial clustering of applications with noise (DBSCAN) operation, a divisive hierarchical clustering operation, or a spectral clustering operation.

4. (canceled)

5. The system of claim 4, wherein the adjusted first distance corresponds to a product of the first distance and the first density score.

6. The system of claim 4, wherein the first distance between the first data point and the second data point corresponds to a Euclidian distance.

7. The system of claim 1,
wherein the processing circuitry is further configured to generate a first intra-cluster distance for the first data point based on the first set of weighted distances, and
wherein the first silhouette score for the first data point is generated based on the first density score and the first intra-cluster distance.

8. The system of claim 7, wherein the first intra-cluster distance corresponds to an average of the first set of weighted distances.

9. The system of claim 7,
wherein the processing circuitry is further configured to determine a set of distances between the first data point and a second set of data points of a second cluster of the first plurality of clusters,
wherein the second cluster is a k-nearest neighbor of the first cluster, and
wherein the first silhouette score for the first data point is generated further based on a first inter-cluster distance that corresponds to an average of the set of distances.

10. The system of claim 1, wherein the first cluster silhouette score for the first cluster corresponds to an average of the first set of silhouette scores.

11. The system of claim 1, wherein the processing circuitry is configured to determine the first density score for the first data point using a k-nearest neighbors' technique.

12. The system of claim 1, wherein the processing circuitry is further configured to extract the plurality of data points from a source file associated with a legacy system.

13. The system of claim 12, wherein the source file corresponds to a code block associated with the legacy system, and wherein the plurality of data points extracted from the source file corresponds to a plurality of business rules associated with the code block.

14. The system of claim 12,
wherein, to execute the clustering operation on the plurality of data points, the processing circuitry is further configured to transform the plurality of data points into a plurality of embedding vectors, with each embedding vector representing a distinct data attribute of the legacy system, and
wherein the first cluster comprises a first set of embedding vectors, of the plurality of embedding vectors, corresponding to the first set of data points.

15. The system of claim 14, wherein the processing circuitry is configured to transform the plurality of data points into the plurality of embedding vectors based on a Universal Sentence Encoder (USE) technique.

16. The system of claim 1, wherein the processing circuitry is further configured to:
compare each of the first plurality of cluster silhouette scores with a threshold score;
determine a second cluster count for the clustering operation in response to at least one of the first plurality of cluster silhouette scores being less than the threshold score, wherein the second cluster count is determined based on the first plurality of cluster silhouette scores; and
re-execute, based on the second cluster count, the clustering operation on the plurality of data points to generate a second plurality of clusters, wherein a number of clusters in the second plurality of clusters is equal to the second cluster count.

17. The system of claim 16, wherein the processing circuitry is further configured to:
compute a second plurality of cluster silhouette scores for the second plurality of clusters;
compare each of the second plurality of cluster silhouette scores with the threshold score; and
generate, in response to each of the second plurality of cluster silhouette scores being equal to or greater than the threshold score, one or more system architecture elements based on the second plurality of clusters.

18. The system of claim 17,
wherein the plurality of data points corresponds to a plurality of business rules associated with a code block,
wherein each cluster, of the second plurality of clusters, includes a set of business rules of the plurality of business rules,
wherein each cluster of the second plurality of clusters corresponds to an entity associated with the code block, and
wherein the one or more system architecture elements are generated in conformity with the entity and the set of business rules associated with each cluster of the second plurality of clusters.

19. The system of claim 16, wherein the processing circuitry is configured to execute a combination of a within-cluster sum of squares (WCSS) analysis and a silhouette analysis on the first plurality of cluster silhouette scores to determine the second cluster count.

20. A method, comprising:
executing, by processing circuitry, based on a first cluster count, a clustering operation on a plurality of data points to generate a first plurality of clusters, with a first cluster comprising a first set of data points, of the plurality of data points;
determining, by the processing circuitry, for a first data point of the first set of data points, a first density score that is indicative of a number of data points in the first cluster within a predefined range from the first data point;
determining, by the processing circuitry, for the first data point, based on the first density score, a first set of weighted distances, with a first weighted distance being determined between the first data point and a second data point of the first set of data points, wherein the first weighted distance is determined by determining a first distance between the first data point and the second data point, and adjusting the first distance based on the first density score;
generating, by the processing circuitry, a first set of silhouette scores for the first set of data points, with a first silhouette score for the first data point generated based on the first density score and the first set of weighted distances; and
computing, by the processing circuitry, a first plurality of cluster silhouette scores for the first plurality of clusters, with a first cluster silhouette score for the first cluster computed based on the first set of silhouette scores, wherein the clustering of the plurality of data points is controlled based on the first plurality of cluster silhouette scores.
